(19) United States
(12) Patent Application Publication
(10) Pub. No.: US 2024/0390199 A1
(43) Pub. Date: Nov. 28, 2024

(54) MOBILE PLASMA COLLECTION TRAILER

(71) Applicants: Thomas Willard Baugh, IV, Waxhaw, NC (US); Mark Rearick Thompson, Litchfield, AZ (US)

(72) Inventors: Thomas Willard Baugh, IV, Waxhaw, NC (US); Mark Rearick Thompson, Litchfield, AZ (US)

(21) Appl. No.: 18/676,130

(22) Filed: May 28, 2024

Related U.S. Application Data
(60) Provisional application No. 63/504,250, filed on May 25, 2023.

(51) Int. Cl. A61G 3/00; F25D 9/00

(52) U.S. Cl. CPC A61G 3/001; F25D 9/005; A61G 2220/16; F25D 2400/30

(57) ABSTRACT

A mobile plasma collection system comprising a mobile platform including a collection chamber, a freezing chamber operationally associated with the collection chamber, a mechanical and electrical chamber operationally associated with the collection chamber and the freezing chamber, wherein the mechanical and electrical chamber is isolated from the freezing chamber, and a refrigeration system operationally associated with the freezing chamber and the mechanical and electrical chamber.

### FIELD OF INVENTION

The present invention relates to devices and methods used to collect, freeze and store biological fluids. More specifically, the present invention relates to mobile devices and methods which allow for the collection, rapid freezing, and storage of blood and plasma from donors.

### BACKGROUND OF THE INVENTION

The collection of blood and plasma from donors has been used for over eighty years to help those in need. There are two main methods of obtaining blood from a donor. The most frequent is to simply take the blood from a vein as whole blood. This blood is typically separated into parts, usually red blood cells and plasma, since most recipients need only a specific component for transfusions. The most common method is collecting the blood from the donor's vein into a container. The amount of blood drawn varies from 200 millilitres to 550 millilitres depending on the country, but 450 millilitres is typical. Blood plasma is a liquid component of blood in which blood cells are absent, but which contains proteins and other constituents of whole blood in suspension. It makes up about 55% of the body's total blood volume. It is the intravascular part of extracellular fluid (all body fluid outside cells). It is mostly water (up to 95% by volume), and contains important dissolved proteins (6-8%; e.g., serum albumins, globulins, and fibrinogen), glucose, clotting factors, electrolytes (Na+, Ca2+, Mg2+, HCO3−, Cl−, etc.), hormones, carbon dioxide, and oxygen. It plays a vital role in an intravascular osmotic effect that keeps electrolyte concentration balanced and protects the body from infection and other blood-related disorders.

Blood plasma is separated from whole blood by spinning a vessel of fresh blood containing an anticoagulant in a centrifuge until the blood cells fall to the bottom of the tube. The blood plasma is then drawn off. For point-of-care testing applications, plasma can be extracted from whole blood via filtration or via agglutination to allow for rapid testing of specific biomarkers. Blood serum is blood plasma without clotting factors. Plasmapheresis is a medical therapy that involves blood plasma extraction, treatment, and reintegration. Fresh frozen plasma is on the WHO Model List of Essential Medicines, the most important medications needed in a basic health system. It is of critical importance in the treatment of many types of trauma which result in blood loss, and is therefore kept stocked universally in all medical facilities capable of treating trauma (e.g., trauma centers, hospitals, and ambulances) or that pose a risk of patient blood loss such as surgical suite facilities.

Stationary blood banks and mobile blood banks are both important components of the blood donation system. Stationary blood banks are located in fixed locations, such as hospitals and clinics. Mobile blood banks are located in vehicles that can be transported to different locations, such as schools, workplaces, and community centers.

There are advantages to using stationary blood banks. Stationary blood banks have more space and equipment than mobile blood banks, which allows them to collect more blood and blood components, process them more efficiently, and to properly store the blood and blood components. Stationary blood banks also have more staff, which allows them to provide better service to donors. However, there are also some disadvantages to using stationary blood banks. Stationary blood banks are typically located in urban areas, which can make it difficult for people in rural areas to donate. Stationary blood banks can also be expensive to operate, which can limit the number of blood banks that are available.

Mobile blood banks offer several advantages over stationary blood banks. Mobile blood banks can be transported to different locations, which makes it easier for people to donate blood. Mobile blood banks are also typically smaller and less expensive than stationary blood banks, which makes them more accessible to rural areas. Unfortunately, there are also some disadvantages to using mobile blood banks. Mobile blood banks have less space and equipment than stationary blood banks, which limits the amount of blood that can be collected. Mobile blood banks also have less staff, which can lead to longer wait times for donors. Mobile blood banks also lack the space and equipment to collect and freeze plasma to the standard temperature of −20 to −25° C. within 12 hours of donation.

Thus, there remains a current need for mobile plasma collection vehicle/trailer which allows for the collection, freezing, and storage of plasma and other blood products.

### SUMMARY

A mobile plasma collection system comprising a mobile platform including a collection chamber, a freezing chamber operationally associated with the collection chamber, a mechanical and electrical chamber operationally associated with the collection chamber and the freezing chamber, wherein the mechanical and electrical chamber is isolated from the freezing chamber, and a refrigeration system operationally associated with the freezing chamber and the mechanical and electrical chamber.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an overhead view of one embodiment of a mobile plasma freezing system of the instant invention.

FIG. 2 is an illustration of a typical freezing system with the freezing chamber and refrigeration system being located within the same chamber.

FIG. 3 is an illustration of Applicant's freezing system with the freezing chamber and refrigeration system being located in separate chambers.

FIG. 4 is an illustration of Applicant's freezing system with the freezing chamber and refrigeration system being located in separate chambers.

FIG. 5 is an illustration of Applicant's freezing system with the freezing chamber and refrigeration system being located in separate chambers.

FIG. 6 is an illustration of Applicant's freezing system with the freezing chamber and refrigeration system being located in separate chambers.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

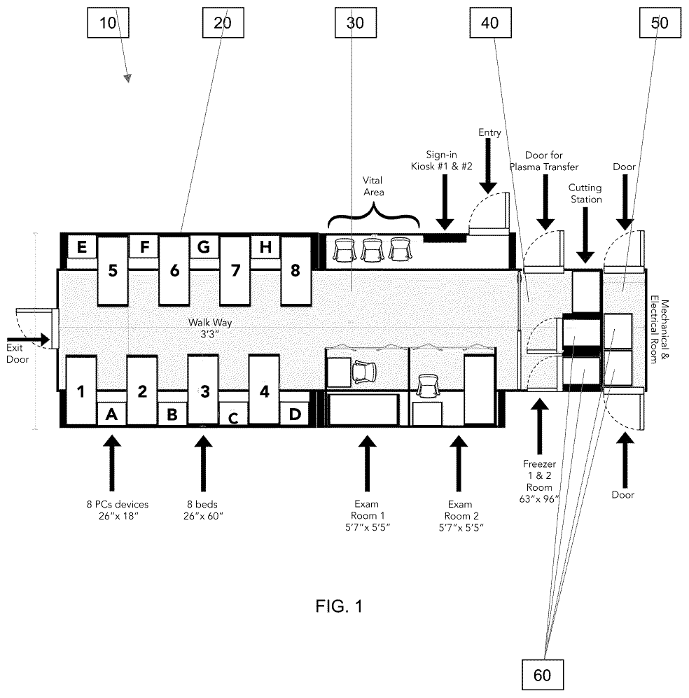

The instant invention includes a mobile plasma collection 10 system comprising a mobile platform 20 including a collection chamber 30, a freezing chamber 40 operationally associated with the collection chamber 30, a mechanical and electrical chamber 50 operationally associated with the collection chamber 30 and the freezing chamber 40, wherein the mechanical and electrical chamber 50 is isolated from the freezing chamber 40, and a refrigeration system 60 operationally associated with the freezing chamber 40 and the mechanical and electrical chamber 50. FIG. 1 illustrates one embodiment of the mobile plasma collection system. The mobile platform 20 of the mobile plasma collection system 10 is selected from the group including a bus, a trailer, an RV, a camper, or a combination thereof.

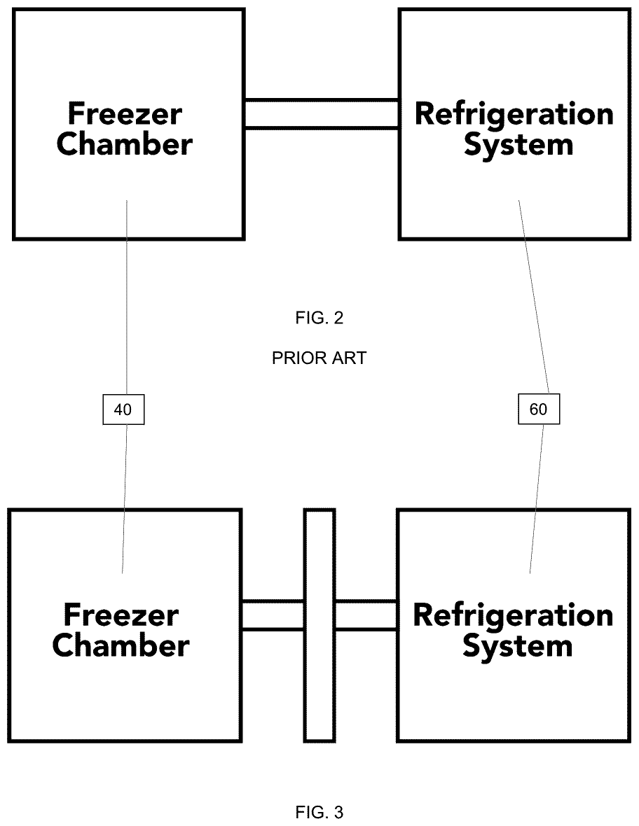

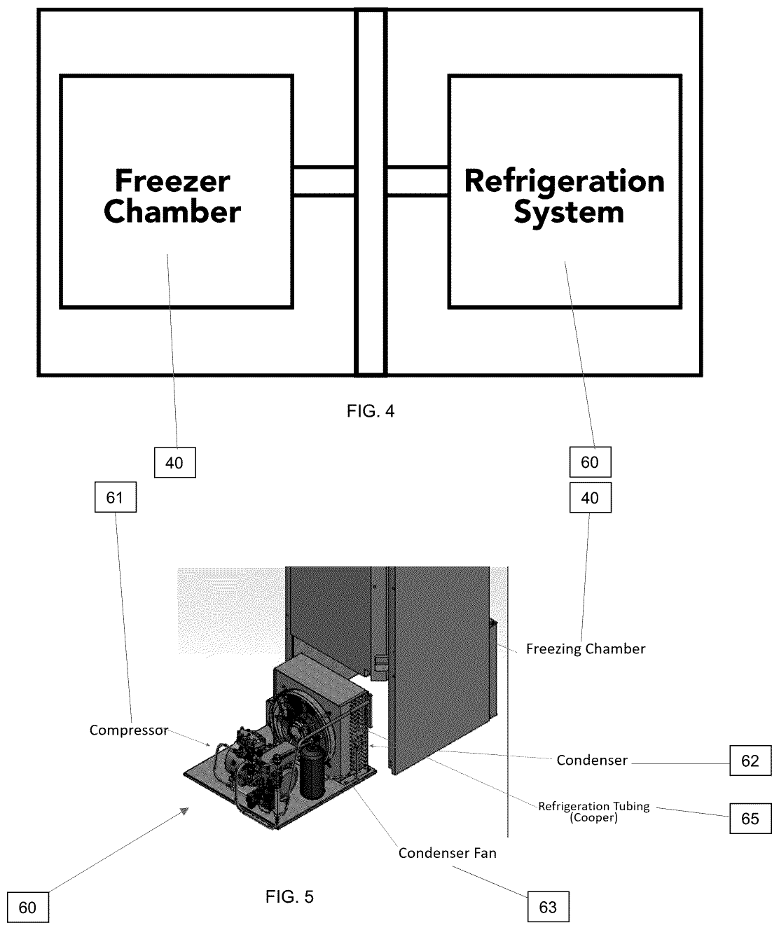

The instant invention is similar to a blood drive donation vehicle with several key differences. Blood is much easier to store once it is collected as it is kept at a temperature of 4° C. This is in contrast to plasma which must be both frozen quickly and maintained at a temperature of −20 to −25° C. To achieve these conditions for plasma collection and storage, specialized equipment is required, namely, a plasma blast freezer which qualifies as a class Il medical device. Existing plasma collection systems are designed with the freezing chamber and the condenser located within the same unit. This configuration generates a great deal of heat and noise within the freezing chamber, a location kept cool with conditioned air. By separating the collection chamber, the freezing chamber, and the condenser, by placing the condenser in a separate mechanical and electrical chamber, the primary source of the heat and noise pollution is placed in an unconditioned environment. This improves the efficiency of the overall system while also improving the work conditions for individuals working within the mobile plasma collection system. The separation of the current system allows for plasma collection in environmental conditions that would not lend themselves to traditional mobile applications. This allows companies to adhere to the same processes that they adhere to in fixed locations for mobile applications. The system also includes but does not require a quick disconnect system which allows quick and easy replacement of the condenser system without purging the coolant lines. This both addresses environmental issues as well as eliminating the need for an HVAC/R tech when replacing units. FIGS. 2-4 illustrate the separation of the freezing chamber 40 from the refrigeration system 60 with FIG. 2 illustrating the prior art and FIGS. 3 and 4 illustrating the separation as described in the current invention.

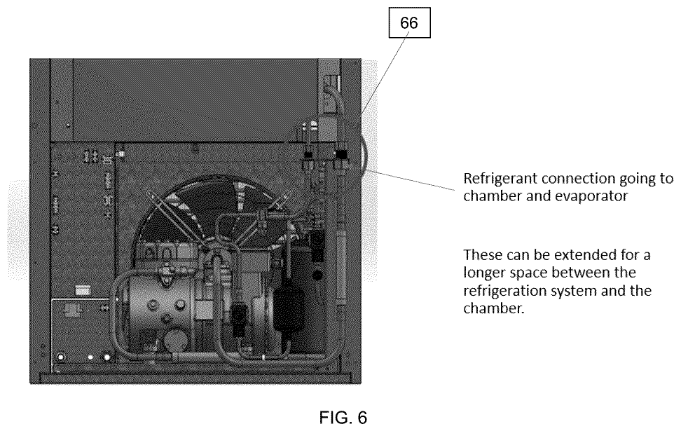

Looking to FIGS. 5 and 6, there is illustrated an embodiment of the freezer chamber 40 and the refrigeration system 60. The refrigeration system includes a compressor 61, a condenser 62, a condenser fan 63, refrigeration tubing 65, and a refrigerant connection 66.

The system includes one or more processors, a computer readable memory and a computer readable storage medium operatively associated with a computing device. The computing device can be any device known in the art including, but not limited to, a desktop computer, a laptop computer, a tablet, a smart phone, a television, or any combination thereof.

The instant invention further includes one or more thermometers operationally associated with each chamber within and outside of the mobile plasma collection system 10. Each thermometer is operationally associated with the computing device. The instant invention further includes one or more cooling fans operationally associated with each chamber within the plasma collection system and the computing device. Each cooling fan is operationally associated with the computing device and the thermometers. The cooling fans are required to dissipate the 21000 BTUs each blast freezer generates per hour as part of the refrigeration system 60.

The instant invention can further comprise an environmental module which includes programming instructions to control the temperature and humidity levels within the mobile plasma collection system 10 and more specifically within the collection chamber 30. The environmental module uses readings from the above mentioned thermometers as well as any other device known in the art to aid in maintaining a consistent and comfortable environment in a mobile platform (e.g., thermostats, air conditioners, humidifiers, de-humidifiers, etc.). The environmental module is operationally associated with the computing device and they coordinate the various components to maintain a consistent and comfortable environment in the collection chamber 30 of mobile platform 20.

The instant invention can further comprise a freezing module which includes programming instructions to control the temperature and humidity levels within the freezing chamber 40 and the refrigeration system 60. The freezing module uses readings from the above mentioned thermometers as well as any other device known in the art and maintaining a consistent environment within a refrigeration system in a mobile platform. The freezing module is operationally associated with the computing device and they coordinate the various components of the refrigeration system to ensure that the collected plasma samples are frozen to a temperature between −20 and 25° C. within 12 hours of their introduction into the refrigeration system 60.

The instant invention can further comprise a mechanical module which includes programming instructions to control the temperature and humidity levels within the mechanical and electrical chamber 50. The mechanical module is operationally associated with the computing device, and they use readings from the above mentioned thermometers and other components to activate and deactivate the one or more cooling fans operationally associated with the mechanical and electrical chamber 50. The mechanical module also controls the RPM's of each cooling fan to efficiently maintain a desired environment within mechanical and electrical chamber 50.

The instant invention further includes one or more power sources which can include, but are not limited to, batteries, solar generators, gas generators, diesel generators, direct hookup to grid electricity, or a combination thereof. The instant invention can further comprise an electrical module which includes programming instructions to coordinate the collection and distribution of electricity to the various components of the mobile plasma collection system 10. The electrical module is operationally associated with the computing device, and they use readings from the various components of the mobile plasma collection system to properly run the various components, modules, and chambers within the mobile plasma collection system 10.

The instant invention can accommodate continuous loading and that will be cooling product within the refrigeration system 60 to between −20 and −25° C. within 12 hours. In one embodiment, the instant invention has a capacity of between one and one hundred 1-liter collection bottles which can be loaded continuously, or simultaneously.

Any method described herein may incorporate any design element contained within this application and any other document/application incorporated by reference herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention may be embodied in other forms without departing from the spirit and the essential attributes thereof, and, accordingly, reference should be made to the appended claims, rather than to the foregoing specification, as indicating the scope of the invention. The invention illustratively disclosed herein suitably may be practiced in the absence of any element which is not specifically disclosed herein.

1. A mobile plasma collection system comprising:
a mobile platform including:
a collection chamber;
a freezing chamber operationally associated with the collection chamber;
a mechanical and electrical chamber operationally associated with the collection chamber and the freezing chamber;
wherein the mechanical and electrical chamber is isolated from the freezing chamber; and
a refrigeration system operationally associated with the freezing chamber and the mechanical and electrical chamber.

2. The mobile plasma collection system of claim 1 wherein the mobile platform is selected from the group including a bus, a trailer, an RV, a camper, or a combination thereof.

3. The mobile plasma collection system of claim 1 wherein the refrigeration system is a blast freezer.

4. The mobile plasma collection system of claim 3 wherein the blast freezer is a class Il medical device capable of freezing the plasma sample to a temperature of at least −20 to −25° C. in a time period of 12 hours or less.

5. The mobile plasma collection system of claim 1 further comprising:
one or more processors, a computer readable memory, and a computer readable storage medium operatively associated with a computing device operatively associated with the freezing chamber, the refrigeration system, and the mechanical and electrical chamber.

6. The mobile plasma collection system of claim 1 wherein the freezing chamber accepts plasma collection bottles ranging in size from 100 ml to 2L.

7. The mobile plasma collection system of claim 5 wherein the freezing chamber accepts plasma collection bottles including 100 ml, 200 ml, 250 ml, 300 ml, 400 ml, 500 ml, 600 ml, 700 ml, 750 ml, 800 ml, 900 ml, 1000 ml, 1250 ml, 1500 ml, 1750 ml, and 2000 ml.

8. A method of freezing plasma comprising the steps of:
providing a mobile plasma collection system comprising:
a mobile platform including:
a collection chamber;
a freezing chamber operationally associated with the collection chamber;
a mechanical and electrical chamber operationally associated with the collection chamber and the freezing chamber;
wherein the mechanical and electrical chamber is isolated from the freezing chamber; and
a refrigeration system operationally associated with the freezing chamber and the mechanical and electrical chamber;
collecting a plasma sample from a patient;
placing the plasma sample into the freezing chamber;
freezing the plasma sample to a temperature of at least −20 to −25° C. in a time period of 12 hours or less.

9. The method of claim 7 wherein the mobile platform is selected from the group including a bus, a trailer, an RV, a camper, or a combination thereof.

10. The method of claim 7 wherein the refrigeration system is a blast freezer.

11. The method of claim 7 wherein the freezing chamber accepts plasma collection bottles ranging in size from 100 ml to 2L.

12. The method of claim 10 wherein the freezer accepts plasma collection bottles including 100 ml, 200 ml, 250 ml, 300 ml, 400 ml, 500 ml, 600 ml, 700 ml, 750 ml, 800 ml, 900 ml, 1000 ml, 1250 ml, 1500 ml, 1750 ml, and 2000 ml.
